(19) United States
(12) Patent Application Publication
(10) Pub. No.: US 2010/0278966 A1
(43) Pub. Date: Nov. 4, 2010

(54) Method of Reducing Cholesterol in Chicken Eggs

(76) Inventor: Pablo De La Mota, Santo Domingo (DO)

Correspondence Address: RUBEN ALCOBA, ESQ., 3399 NW 72 AVENUE, SUITE211, MIAMI, FL, 33122, US

(21) Appl. No.: 12/434,012

(22) Filed: May 1, 2009

(51) Int. Cl. A23K 1/18; A23K 1/00; A23L 1/303; A23K 1/175; A23K 1/14; A23K 1/02

(52) U.S. Cl. 426/2; 426/73; 426/72; 426/648; 426/623; 426/635

(57) ABSTRACT

A shark liver oil chicken feed for reducing cholesterol in chicken eggs and a method for producing eggs that have a lower cholesterol content. The shark liver oil chicken feed comprises of chicken feed and an ounce of shark liver oil that is added to the chicken feed. The method consists of feeding egg laying hens an ounce of shark liver oil daily along with chicken feed. The ounce of shark liver oil is one percent, by weight, of each hens daily chicken feed. The eggs are to be collected on the seventh week from the first feeding of the shark liver oil chicken feed.

### BACKGROUND

The present invention is related to the field of feeding a nutritional supplement to egg laying hens. The nutritional supplement lowers the cholesterol content of the eggs produced by the egg laying hens.

Since 1950, humans have consumed less eggs. One of the reasons for the reduction is the advisory given by The American College of Cardiology. The advisory was that humans should consume no more than 300 mg of cholesterol a day. It is estimated that an egg has an average content of 213 mg of cholesterol. The level of cholesterol in each egg limits how many eggs a human should consume weekly to a range from 3-6 eggs. If a human were to eat more than the range for a sustained period, the risks of contracting a cardiovascular disease increases greatly.

Eggs are a very important nutritional food source. Because of the advisory, significant research has been made in the field of producing eggs that have a reduced cholesterol content. Research has shown that one way of reducing the cholesterol content of eggs is to modify the chicken feed of egg laying hens. The following U.S. Patents disclose methods for reducing the cholesterol content of Eggs: Havens, U.S. Pat. No. 5,091,195; Elkin et al., U.S. Pat. No. 6,177,121; Stilborn et al., U.S. Pat. No. 6,391,348; Slaugh, U.S. Pat. No. 6,436,451; and Pan et al., U.S. Pat. No. 7,157,107.

According to the World Health Organization, more than thirty percent of all deaths in the world are due to cardiovascular diseases. One reason for the high rate of cardiovascular disease is directly related to the diet of present day humans. Most humans diet plans consists of diets having a high content of saturated fats. Humans having diets high in saturated fats and that have either a sedentary life style, who suffer from high stress levels, and/or who consume large amounts of alcohol and/or tobacco products are the most likely to suffer from a cardiovascular disease. The warning given by the American College of Cardiology is one of the reasons in the reduction of the consumption of eggs.

For the foregoing reasons, there is a need for providing a skark liver oil chicken feed for reducing cholesterol in chicken eggs and a method for producing eggs having a lower cholesterol content, the method comprises adding shark liver oil to chicken feed.

### SUMMARY

The present invention is directed to a shark liver oil chicken feed for reducing cholesterol in chicken eggs. The shark liver oil chicken feed comprises of a daily amount of chicken feed and an ounce of shark liver oil that is added to the daily amount of chicken feed. The present invention is also directed to a method for producing eggs that have reduced cholesterol content. The method comprises adding an ounce of shark liver oil to the daily chicken feed of an egg laying hen. The ounce of shark liver oil is one percent, by weight, of each hens daily food intake. The eggs are to be collected on the seventh week from the first feeding of the chicken feed containing the shark liver oil.

Adding the shark liver oil to the chicken feed of egg laying hens has yielded eggs having at least 208 mg of cholesterol per 100 g.

An object of the present invention is to reduce the amount of cholesterol in the eggs of egg laying chickens.

Another object of the present invention is to increase the consumption of eggs.

Yet, another object of the present invention is provide a shark liver oil chicken feed that will reduce the amount of cholesterol in the eggs of egg laying chickens.

Yet, a further object of the present invention is to provide eggs that have a greater nutritional value than the eggs presently sold to the public.

These and other features, aspects, and advantages of the present invention will become better understood with reference to the following description and appended claims.

### DESCRIPTION

The present invention is directed to a shark liver oil chicken feed for reducing cholesterol in chicken eggs. The shark liver oil chicken feed comprises of a daily amount of chicken feed and an ounce of shark liver oil that is added to the daily amount of chicken feed. The shark liver oil chicken feed might comprise of, by weight, fifty eight point five percent corn, twenty seven percent of soybean, three percent vegetable fat, one percent molasses, one percent vitamin mix, one percent mineral mix, one percent shark liver oil, point six percent salt, point five percent phosphate, point four percent calcium, and six percent of other non-essential materials.

The shark liver oil chicken feed for reducing cholesterol in chicken eggs is used as follows: providing the shark liver oil chicken feed; providing an egg laying hen; daily feeding the egg laying hen the shark liver oil chicken feed; and collecting eggs laid by the egg laying hen seven weeks after the first feeding of the shark liver oil chicken feed.

The present invention is also directed to a method of reducing cholesterol in chicken eggs, the method comprising the steps of providing a daily amount of chicken feed for an egg laying hen; adding an ounce of shark liver oil to the chicken feed, thereby producing a shark liver oil chicken feed; and feeding the egg laying hen the shark liver oil chicken feed. The method might further comprise the step of collecting eggs from the egg laying hen seven weeks after the first feeding of the shark liver oil chicken feed.

In an embodiment of the present invention, the shark liver oil chicken feed might comprise of, by weight, fifty eight point five percent corn, twenty seven percent of soybean, three percent vegetable fat, one percent molasses, one percent vitamin mix, one percent mineral mix, one percent shark liver oil, point six percent salt, point five percent phosphate, point four percent calcium, and six percent of other non-essential materials.

Numerous experiments during the last few decades have shown the benefits of shark liver oil when promoting good health, it is especially helpful to the cardiovascular system. Shark liver oil is rich in alkylglycerols and contains pristane, squalene, vitamins A, D, omega 3 and 6 fatty acids, triglycerides, glycerol ethers, and fatty alcohols.

A pioneer of fatty acid research is Ralph Holman. In 1962, Mr. Holman discovered that the low frequency of death due to cardiovascular disease in the Japanese and Eskimo communities was directly linked to the high levels of omega 3 and 6 fatty acids in their diets. Shark liver oil is rich in omega 3 and 6 fatty acids.

The shark liver oil chicken feed is continuously given to the egg laying hens so that omega fatty acids are assimilated within the hens during the segmentation and gastrulation stages. It is the inventor's belief that the omega fatty acids reduce the formation of cholesterol within the eggs of the egg laying hens.

The inventor of the present invention has continuously provided egg laying hens with the above described shark liver oil chicken feed, thereby ensuring that the egg laying hens being studied asymilate the shark liver oil during the segmentation and gastrulation phases of egg development. It is the inventor'e belief that the shark liver oil's properties help reduce the eggs' cholesterol during the formation of the egg.

The practice of the invention is illustrated but not limited to the following example.

Example: The shark liver oil chicken feed of the present invention was tested on 12 egg laying hens. The hens belonged to the company Hy-Line breed Hy-Line W98. The hens were 55 weeks old when the test was carried out. The hens were fed the shark liver oil chicken feed for a period of five weeks before eggs were collected from the egg laying hens. The eggs were then sent to laboratories to analyze the cholesterol content of the eggs.

The shark liver oil chicken feed could be mixed together during the manufacturing of the chicken feed or it could be mixed with the daily amount of chicken feed consumed by each hen. When manually mixing the daily amount of chicken feed with the shark liver oil, care has to be taken not to give more than an ounce of shark liver oil to each egg laying chicken.

The list bellow shows the ingredients needed to manufacture the shark liver oil chicken feed.

| | |
|---|---|
| Total | 100.0% |
| Corn | 58.5% |
| Soybean | 27.0% |
| Other | 6.0% |
| Vegetable Fat | 3.0% |
| Molasses | 1.0% |
| Vitamin Mix | 1.0% |
| Mineral Mix | 1.0% |
| Shark liver oil | 1.0% |
| Salt | 0.6% |
| Phosphate | 0.5% |
| Calcium | 0.4% |

In another embodiment of the present invention, the ounce of shark liver oil might be mixed with the daily liquid intake of water of the egg laying hen. The mixture is then administered to the hen throughout a 24 hour period.

The tests carried out by the inventor showed that the egg laying hens suffered no ill effects from the consumption of the shark liver oil. Note, no claim is being made as to side affects due to using more than the dosage suggested in this application. In fact, when higher dosages were used, it was shown that the egg laying hens produced less eggs. However, the plumage of the egg laying hens became darker.

To carry out the experiment, it was necessary to allow six complete weeks to pass from the first feeding of the shark liver oil. This ensured that any eggs delivered by the egg laying hens were free of any influences that were not directly connected to the shark liver oil.

On the seventh week from the first feeding of the shark liver oil, two eggs were collected from each egg laying hen for analysis. The contents of the eggs were taken and mixed so that the yolk and the egg white of the egg were equally distributed throughout the mixture, then 100 mg samples of the mixture were submitted for gas chromatography testing using a mass spectrometer. The inventor received a Report of Analysis from Eurofins Scientific, Inc., wherein the sample submitted yielded a result of 208 mg of cholesterol in a 100 g sample.

In Gas Chromatography the sample is saponified with potassium hydroxide. A liquid-liquid extraction is performed, collecting the unsaponifiable fraction in toluene. An aliquot of the toluene extract is dried down, and then redissolved in dimethylformamide. The sterols in the concentrated extract are derivatized to trimethylsilyl ethers which are then extracted into heptane containing internal standard. The heptane is injected into a gas chromatograph, and the cholesterol determined from a standard curve of known standards and an internal standard.

The USDA states on their webpage that a 100 mg sample of yolk and egg white in a normal egg contains about 423 mg of cholesterol. From the average content described on the USDA webpage, the inventor can safely say that the present invention reduces the content of cholesteral at least by fifty one percent.

The tests show that egg laying hens nurished with the shark liver oil chicken feed or the shark liver oil liquid mixture, hereinafter shark liver oil supplements, produced eggs having a lower cholesterol content than egg laying hens not nurished with the shark liver oil supplements.

An advantage of the present invention is that it reduces the amount of cholesterol in eggs of egg laying chickens.

Another advantage of the present invention is that it increase the consumption of eggs.

Yet, another advantage of the present invention is that it provides a daily chicken feed that reduces the amount of cholesterol in the eggs of egg laying chickens.

A further advantage of the present invention is that it provides eggs that have a greater nutritional value than the eggs presently sold to the public.

Although the present invention has been described in considerable detail with reference to certain preferred versions thereof, other versions are possible. Therefore the spirit and the scope of the claims should not be limited to the description of the preferred versions contained herein.

What is claimed is:

1. A shark liver oil chicken feed for reducing cholesterol in chicken eggs, the daily chicken feed comprises:
a daily amount of chicken feed; and
an ounce of shark liver oil, the shark liver oil is added to the chicken feed.

2. The shark liver oil chicken feed of claim 1, wherein the shark liver oil chicken feed comprises of, by weight, fifty eight point five percent corn, twenty seven percent of soybean, three percent vegetable fat, one percent molasses, one percent vitamin mix, one percent mineral mix, one percent shark liver oil, point six percent salt, point five percent phosphate, point four percent calcium, and six percent of other non-essential materials.

3. A method of using the shark liver oil chicken feed of claim 1, comprising the steps of:
providing the shark liver oil chicken feed;
providing an egg laying hen;
daily feeding the egg laying hen the shark liver oil chicken feed; and
collecting eggs laid by the egg laying hen five weeks after the first feeding of the shark liver oil chicken feed.

4. A method of reducing cholesterol in chicken eggs, the method comprising the steps of;
providing a daily amount of chicken feed for an egg laying hen;
providing an egg laying hen;
adding an ounce of shark liver oil to the chicken feed, thereby producing a shark liver oil chicken feed; and
feeding the egg laying hen the shark liver oil chicken feed.

5. The method of claim 4, further comprising collecting the eggs from the egg laying hen five weeks after the first feeding of the shark liver oil chicken feed.

6. The method of claim 5, wherein the shark liver oil chicken feed comprises of, by weight, fifty eight point five percent corn, twenty seven percent of soybean, three percent vegetable fat, one percent molasses, one percent vitamin mix, one percent mineral mix, one percent shark liver oil, point six percent salt, point five percent phosphate, point four percent calcium, and six percent of other non-essential materials.

7. The method of claim 4, wherein the shark liver oil chicken feed comprises of, by weight, fifty eight point five percent corn, twenty seven percent of soybean, three percent vegetable fat, one percent molasses, one percent vitamin mix, one percent mineral mix, one percent shark liver oil, point six percent salt, point five percent phosphate, point four percent calcium, and six percent of other non-essential materials.

8. A shark liver oil mixture for reducing the cholesterol content of an egg, the mixture comprises of:
An amount of water equal to the daily amount of water intake required by an egg laying hen during a 24 hour period; and
An ounce of shark liver oil, the shark liver oil is mixed with the water.

9. A method of using the shark liver oil mixture of claim 8 to reduce the cholesterol content of an egg laying hen, the method comprising the steps of:
providing the shark liver oil mixture;
providing an egg laying hen; and
administering the mixture throughout the span of a 24 hour period to the egg laying hen.

10. The method of claim 9, further comprising the step of collecting the eggs from the egg laying hen seven weeks after the first administering of the mixture.
